(19) United States
(12) Patent Application Publication
(10) Pub. No.: US 2018/0131985 A1
(43) Pub. Date: May 10, 2018

(54) METHODS AND SYSTEMS OF A LOCAL VIDEO-HUB DEVICE FOR PUSHING MANAGED VIDEO CONTENT OVER A DISPLAY OF ANOTHER VIDEO SOURCE

(71) Applicants: JAY VIJAYAN, dublin, CA (US); GURU SANKARARAMAN, dublin, CA (US); ANAND RAMAKOTTI, dublin, CA (US); SIGMUNDO BAUTISTA, alemeda, CA (US); ROBERT KENNEDY MANOHARAN, CHENNAI (IN)

(72) Inventors: JAY VIJAYAN, dublin, CA (US); GURU SANKARARAMAN, dublin, CA (US); ANAND RAMAKOTTI, dublin, CA (US); SIGMUNDO BAUTISTA, alemeda, CA (US); ROBERT KENNEDY MANOHARAN, CHENNAI (IN)

(21) Appl. No.: 15/669,956

(22) Filed: Aug. 6, 2017

Related U.S. Application Data
(60) Provisional application No. 62/373,348, filed on Aug. 11, 2016.

(51) Int. Cl. H04N 21/2668; H04N 21/81; H04N 21/431; H04N 21/258

(52) U.S. Cl. CPC H04N 21/2668; H04N 21/812; G06Q 50/01; H04N 21/25891; H04N 21/4316

(57) ABSTRACT

In one aspect, a method for a local business entity to generate a managed video that is generated for a specific customer on the premises of the local business entity and to overlay the customized video content over an external video feed is provided. The method includes the step of communicatively coupling the local video-overlay device with a video monitor. The method includes the step of receiving a managed video content with the local video-overlay device. The method includes the step of receiving an external video-content with the local video-overlay device. The method includes the step of configuring a display of the managed video content over the external video content. The method includes the step of merging the managed video content and the external video content into a single video feed. The method includes the step of displaying the single content feed with the video monitor.

This application claims priority to U.S. Provisional Application No. 62/373,348, titled and METHODS AND SYSTEMS OF APPLICATION MANAGEMENT filed on 11 Aug. 2016. This provisional application is incorporated by reference in its entirety.

### BACKGROUND

### 1. Field

This application relates the display of digital video content and more specifically to a system, article of manufacture and method for a local video hub device for pushing managed video content over a display of another video source.

### 2. Related Art

Currently, digital signage at stores, restaurants, etc. can be shown to customers. However, the content of the digital signage may be static and created without a current knowledge of the customer's specific attributes. Accordingly, improvements to localized media content with a local video-hub device for pushing managed video content over a display are desired.

### SUMMARY

In one aspect, a method for a local business entity to generate a managed video that is generated for a specific customer on the premises of the local business entity and to overlay the customized video content over an external video feed is provided. The method includes the step of communicatively coupling the local video-overlay device with a video monitor. The method includes the step of receiving a managed video content with the local video-overlay device. The method includes the step of receiving an external video-content with the local video-overlay device. The method includes the step of configuring a display of the managed video content over the external video content. The method includes the step of merging the managed video content and the external video content into a single video feed. The method includes the step of displaying the single content feed with the video monitor.

### BRIEF DESCRIPTION OF THE DRAWINGS

FIG. 1 illustrates an example system for local video-hub device for pushing managed video content over a display of another video source, according to some embodiments.

FIG. 2 depicts an exemplary computing system that can be configured to perform any one of the processes provided herein.

FIG. 3 is a block diagram of a sample-computing environment that can be utilized to implement various embodiments.

FIG. 4 illustrates an example system for an over-the-top television box for pushing managed content while displaying another video source, according to some embodiments.

FIG. 5 illustrates an example process of a video hub for pushing managed content while displaying another video source, according to some embodiments.

FIG. 6 illustrates another example process of a video hub for pushing managed content while displaying another video source, according to some embodiments.

FIG. 7 illustrates an example process implemented by process 600, according to some embodiments.

FIG. 8 illustrates a process implemented by process 600, according to some embodiments.

FIG. 9 illustrates a process implemented by process 600 for determining an application topic, according to some embodiments.

FIG. 10 illustrates a process implemented by process 600, according to some embodiments.

FIG. 11 illustrates a process implemented by process 600, according to some embodiments.

FIG. 12 illustrates a screen shot of code instructions pseudo-code, according to some embodiments.

FIG. 13 illustrates an example process for a local business entity to generated a managed video that is generated for a specific customer on the premises of the local business entity and to overlay the customized video content over an external video feed, according to some embodiments.

The Figures described above are a representative set, and are not an exhaustive with respect to embodying the invention.

### DESCRIPTION

Disclosed are a system, method, and article of manufacture for methods and systems of a local video-hub device for pushing managed video content over a display of another video source. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘In an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Example Definitions

Application can be a computer program designed to perform a group of coordinated functions, tasks and/or activities for the benefit of the user.

External video content can be video content from existing video source such as cable television, satellite television, video game sources and/or other video sourced content. External video content can be from a third-party source (e.g. a cable television company, a television station, a YouTube® channel, an online social network video channel, etc.).

Picture-in-picture (PiP) can be a feature of some television/monitor receivers and similar devices. One program (e.g. a channel) can displayed on the full television screen at the same time as one or more other programs are displayed in inset windows.

Push technology can be a style of Internet-based communication where the request for a given transaction is initiated by the publisher or central server.

Recommendation system can be a subclass of information filtering system that seeks to predict the ‘rating’ or ‘preference’ that a user would give to an item.

Representational state transfer (REST) can include a way of providing interoperability between computer systems on the Internet. REST-compliant Web services can enable requesting systems to access and manipulate textual representations of Web resources using a uniform and predefined set of stateless operations.

Screen sharing can involve sharing access to a given computer screen. Screen sharing software can use various different methods to allow sharing a screen remotely with one or more other users for collaboration purposes and/or other objectives.

WebSocket can be a computer communications protocol, providing full-duplex communication channels over a single TCP connection.

Exemplary Computer Architecture and Systems

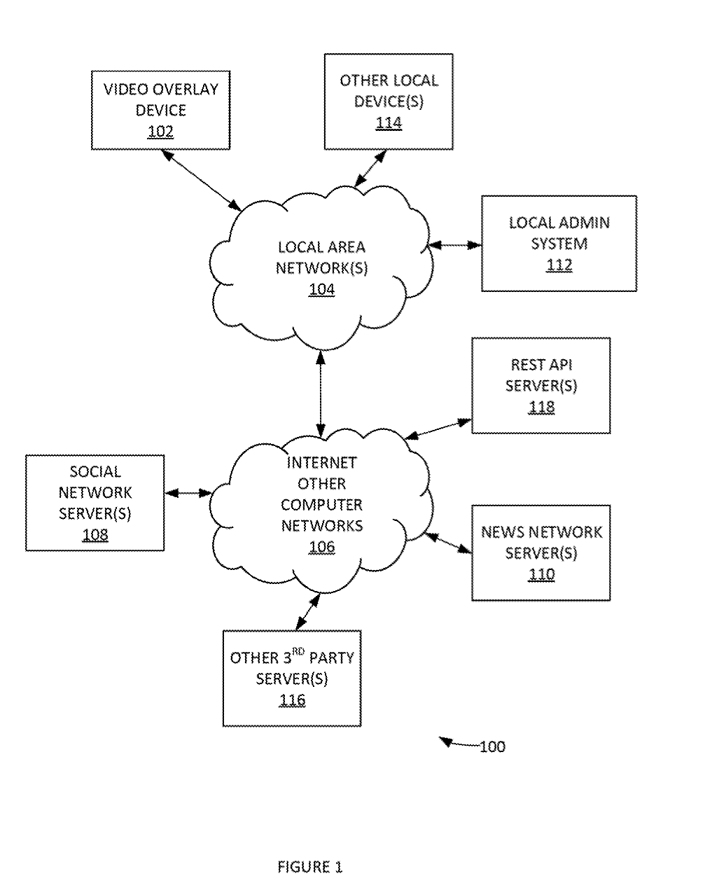

FIG. 1 illustrates an example system 100 for local video-hub device for pushing managed video content over a display of another video source, according to some embodiments. System 100 can include various computer and/or cellular data networks 100. Networks 106 can include the Internet, local area networks (LAN) 104, enterprise wide networks, text messaging networks (e.g. short messaging service (SMS) networks, multimedia messaging service (MMS) networks, proprietary messaging networks, instant messaging service networks, email systems, etc. Networks 106 can be used to communicate messages and/or other information from the various entities of system 100.

In one example embodiment, a video-overlay device (e.g. a video hub device, system hardware 406 infra, video-overlay device 618 infra, etc.) can be connected to a television and/or other monitor with an existing video source. Examples of video sources can include, inter alia: cable TV/satellite sources, video game sources and/or other video sourced content. The video-overlay device can display the current video content, as well as, managed content pushed to the device via coded instructions. The custom content displays can be configurable. The custom content displays can show as an overlaid PIP, digital banner (e.g. left, right, top or bottom), notification messages, and/or take over the full screen and vice-versa. The content pushed to the video-overlay device can be managed for the video-overlay device. Content can be advertisements, videos, text, sound or sound bites, other application data such as, inter alia: email, social feed, business application data. The system hardware can replace the live television video with a custom video when available from cloud-computing services. It is noted that system 100 can utilize systems 200-400 as well.

Video-overlay device 102 can be a video hub that overlays locally generated custom video content over external video content on local video monitor(s). Other local devices 114 can obtain user information, vehicle location information, vehicle status information, administration input information, vehicle telematics information, etc. Other local devices 114 can include local video monitor(s). Local administrator system 112 can manage the types of video content output by video-overlay device 102. Local administrator system 112 can manage the format of video displays on local video monitor(s). REST API servers 118 can send instructions to the video-overlay device 102 with the custom video content. In one example, custom video content can be customized to a customer or other user of the business that currently at the businesses building. News network server 110 can provide news and/or other video content to video-overlay device 102. Social network servers can provide social network content to video-overlay device 102. Other third-party servers 118 can provide other video/audio content to video-overlay device 102. In some embodiments, system 100 can include modules of systems 400 and/or 600 as well. Local area networks 104 can be a computer network that interconnects computers within a limited area such as the business or enterprise buildings managed/owned by a business or other entity.

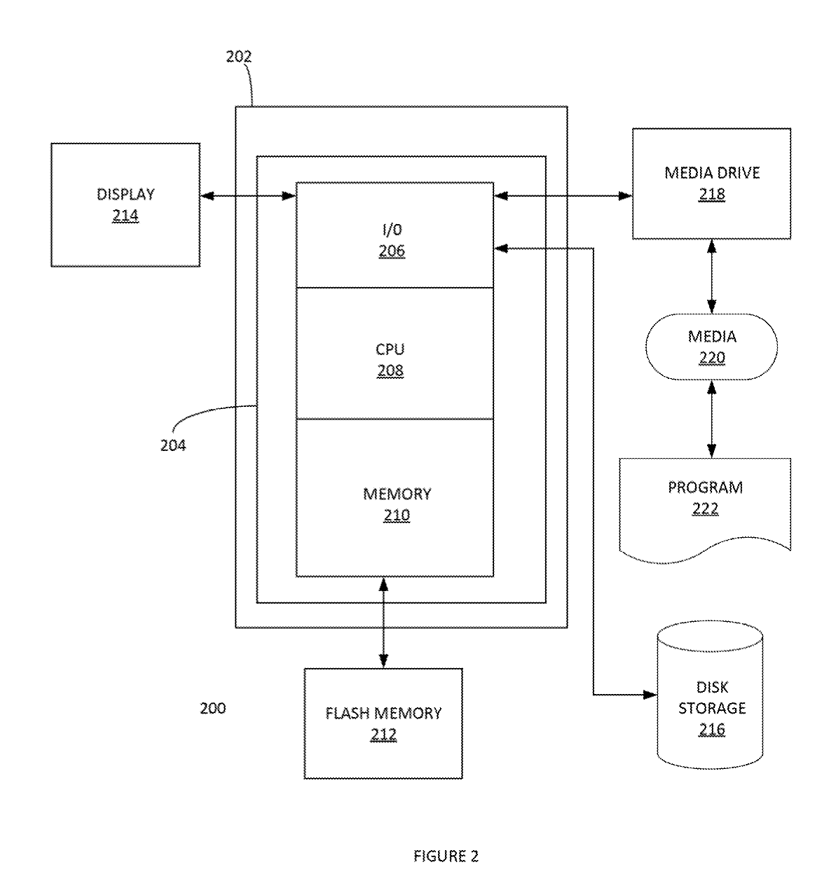

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

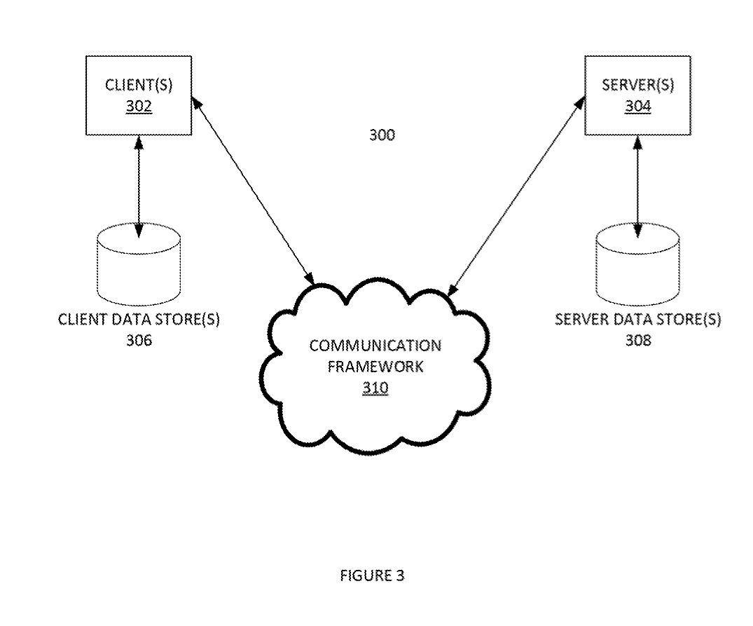

FIG. 3 is a block diagram of a sample-computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform. it is noted that various functionalities of systems 100-300 can be implemented as virtual systems and/or in a cloud-computing platform (e.g. managed-content server in a cloud-computing platform television system 402 infra), according to some embodiments.

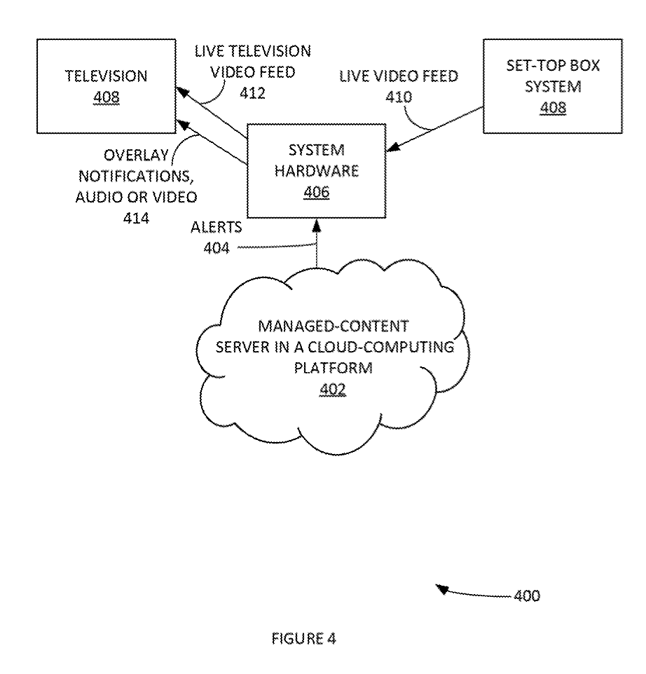

FIG. 4 illustrates an example system 400 for an over-the-top television box (Video hub) for pushing managed content while displaying another video source, according to some embodiments. In some embodiments, the over-the-top television box can be a video-hub device such as system hardware 406. System hardware 406 can pass through an existing video source and overlay an application user interface (UI) and display on a monitor or television (e.g. Zidoo X9®, Zidoo X9S®, etc.). An application on system hardware 406 that can accept pushed video (and/or audio) content or links to content such as, inter alia, text, image, sound, video, internet feeds (e.g. social media, news, RSS etc.). The application in system hardware 406 can then display this video content with the dimension and time parameters associated with the pushed content. An administration application (e.g. web administrator system 602 infra, etc.) on the world wide web to setup the customer-side system using system 400. A REST API (e.g. REST API system 608) can send instructions to the system hardware 406 with the custom video content. An application on the world wide web can then manage which content is pushed to the device using a persistent connection and/or event based notification.

Exemplary Methods

Various methods of application management are provided herein.

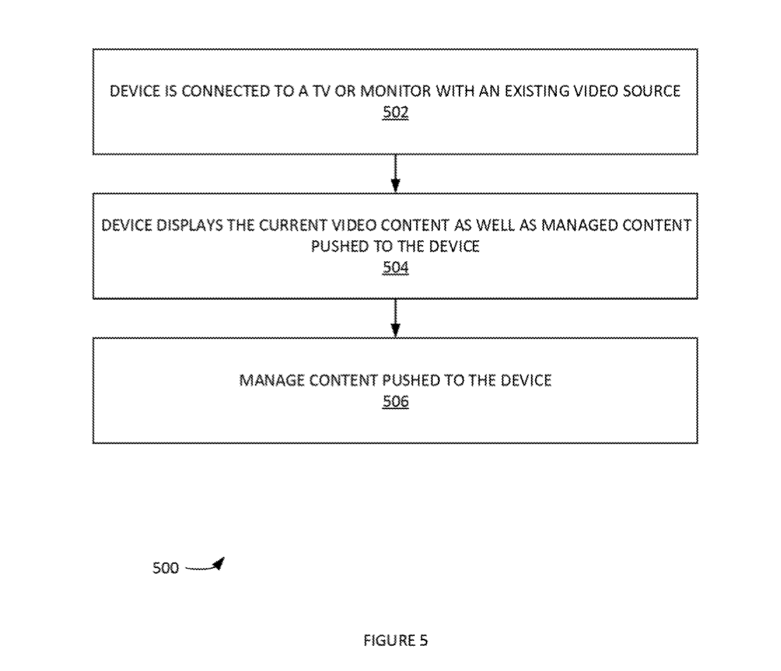

FIG. 5 illustrates an example process 500 of a video hub for pushing managed content while displaying another video source, according to some embodiments. A device (e.g. video-overlay device 618, etc.) can be connected to a television or monitor with an existing video source such as cable TV/satellite, video game and/or other video-sourced content. Said device can display the current video content as well as managed content pushed to the device. The displays can be configurable to show as a PiP, banner (e.g. left, right, top or bottom), notification messages, or take over the full screen and vice-versa. The content can be pushed to the device is managed for the device. Content can be advertisements, videos, text, sound and/or sound bites, other application data like email, social feed, business application data, etc.

More specifically, in step 502, a device can be connected to a television or monitor with an existing video source. In step 504, the device displays the current video content as well as managed content pushed to the device. In step 506, process 500 can manage content pushed to the device.

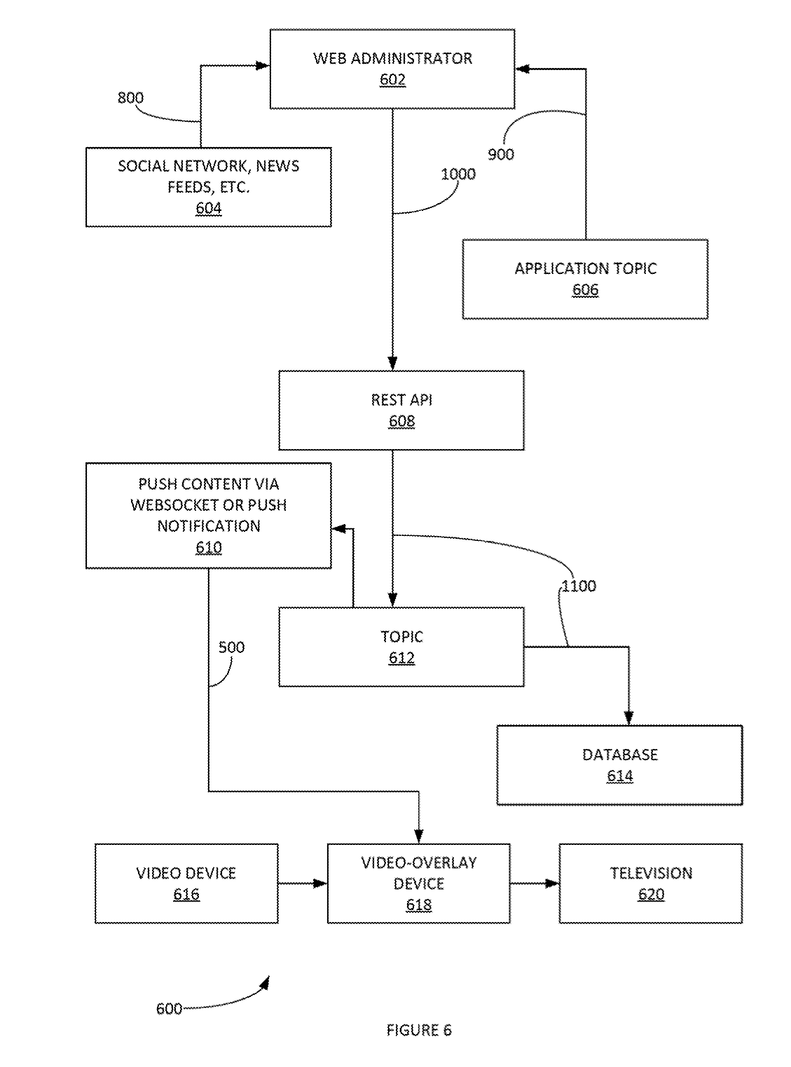

FIG. 6 illustrates another example process 600 of a video hub for pushing managed content while displaying another video source, according to some embodiments. Process 600 can utilize a device that can pass through an existing video source and overlay an application user interface (UI) in a display on a monitor or television. Process 600 can provide an application that can accept pushed content and/or links to content such as text, image, sound, video, etc. Process 600 can display this with the dimension and time parameters associated with the pushed content. Process 600 can also provide various means to configure the push content. more specifically, process 600 can implement processes 700-1100. additionally, web administrator 602 can be part of an administrative layer of process 600. Social network, news, feeds, etc. 604 can be part of an Internet layer of process 600. Application topic 606 can be part of an Application Queue layer of process 600. Rest API 608 and Push Content module 610 and Topic 612 can be part of an Application Server layer of process 600. Topic 612 can be a part of message queue layer of process 600. Database 614 can be a part of database layer of process 600. Video device 616, video-overlay device 618, television 620 can be a part of the television hub layer of process 600.

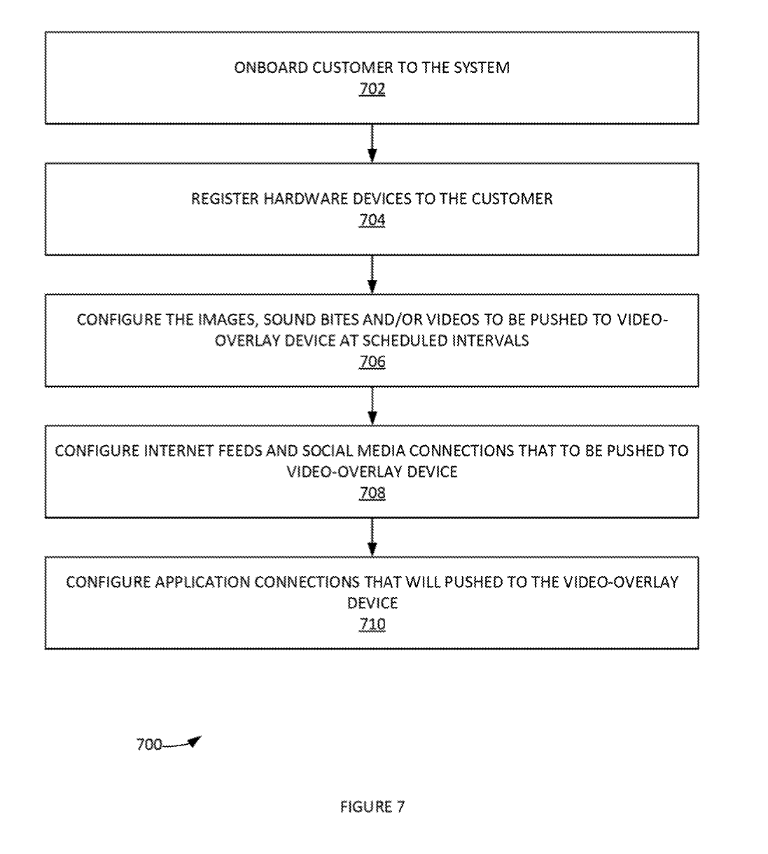

FIG. 7 illustrates an example process 700, implemented by process 600, according to some embodiments. In step 702, process 700 can onboard customer to the system. In step 704, process 700 can register hardware devices to the customer. In step 706, process 700 can configure the images, sound bites and/or videos to be pushed to video-overlay device at scheduled intervals. In step 708, process 700 can configure internet feeds (e.g. news feeds, etc.) and social media connections 604 (e.g. Facebook®, Twitter®, etc.) to be pushed to a video-overlay device 618. In step 710, process 700 can configure application connections that will pushed to the video-overlay device 618.

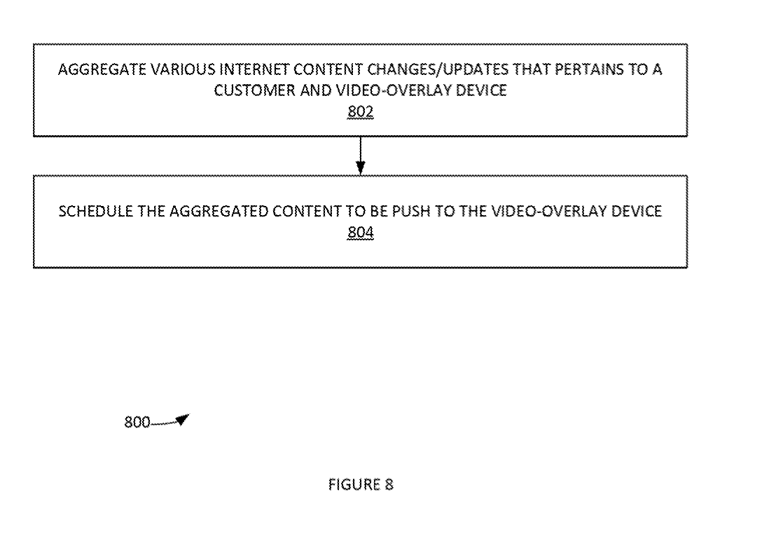

FIG. 8 illustrates a process implemented by process 600, according to some embodiments. In step 802, process 800 aggregates various Internet content changes/updates that pertains to a customer and video-overlay device 618. In step 804, process 800 schedules the aggregated content to be push to the video-overlay device 618.

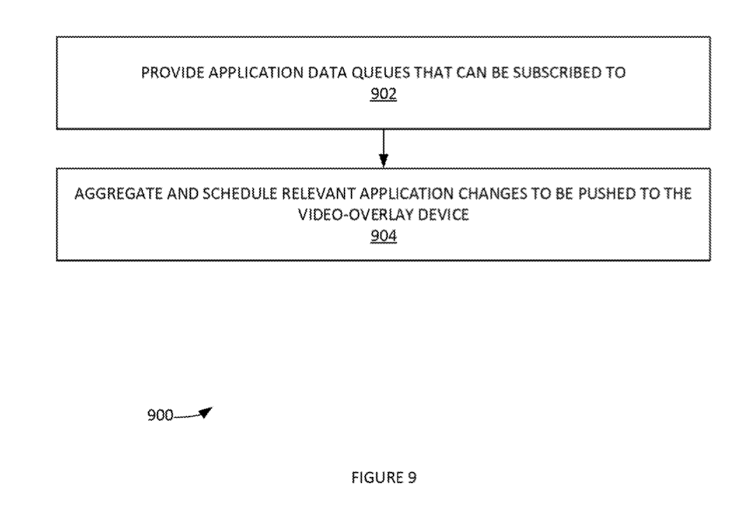

FIG. 9 illustrates a process implemented by process 600 for determining an application topic (e.g. Application Topic 606, etc.), according to some embodiments. In step 902, process 900 provides various application data queues that can be subscribed to. In step 904, process 900 aggregates and schedules relevant application changes to be pushed to video-overlay device 618.

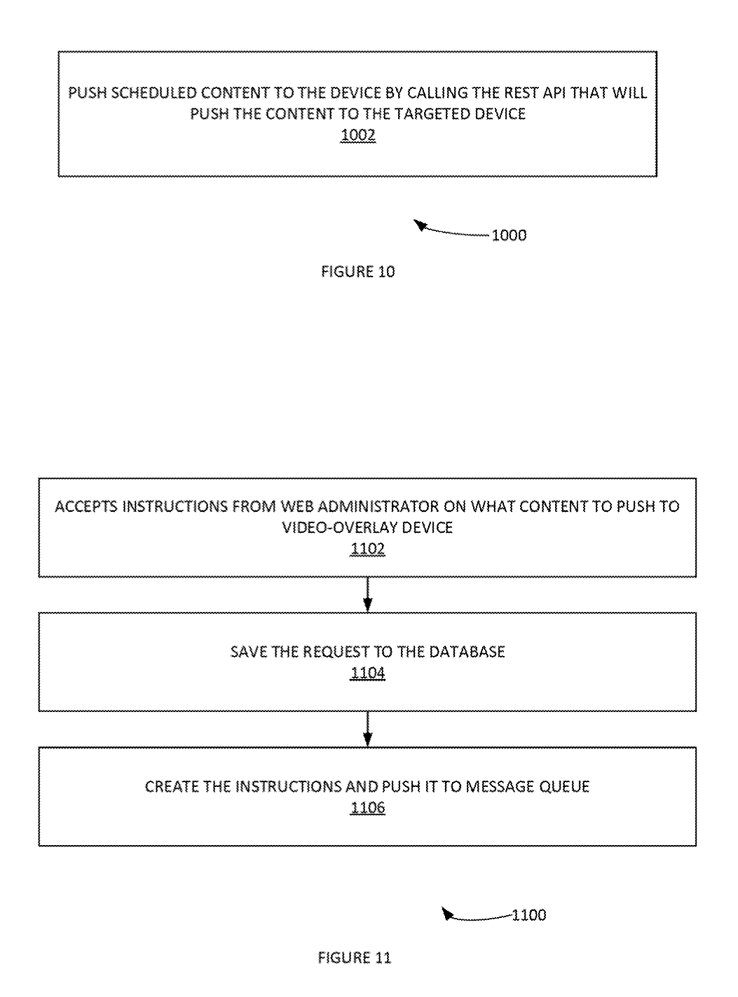

FIG. 10 illustrates a process 1000 implemented by process 600, according to some embodiments. In step 1002, process 1000 pushes scheduled content to the device by calling Rest API 608 that will push the content to the targeted device. Web Administrator 602 can manage processes 800-1000.

FIG. 11 illustrates a process 1100 implemented by process 600, according to some embodiments. In step 1102, process 1100 accepts instructions from web administrator 602 on what content to push to video-overlay device 618. In step 1104, process 1100 saves the request to the database 614. In step 1106, process 1100 creates the instructions and push it to a message queue. Process 1100 can be implemented by a rest API application server 608.

Returning to process 600, an application can listen to the message queue topic 612 for messages pertaining to a specific device and translate it to content to be pushed to the video-overlay device 618 in step 610. Video-overlay device 618 can enable video feeds to pass through it. Video-overlay device 618 can input coded instructions to be able to display custom content overlaid on the video source. In television hub layer, video device 616 video-overlay device 618, television 620. Video device 616 can be a video source. Example video sources can include, inter alia: broadcast television video fees, cable video feeds, satellite video feeds, Blu-ray® video feeds, etc.

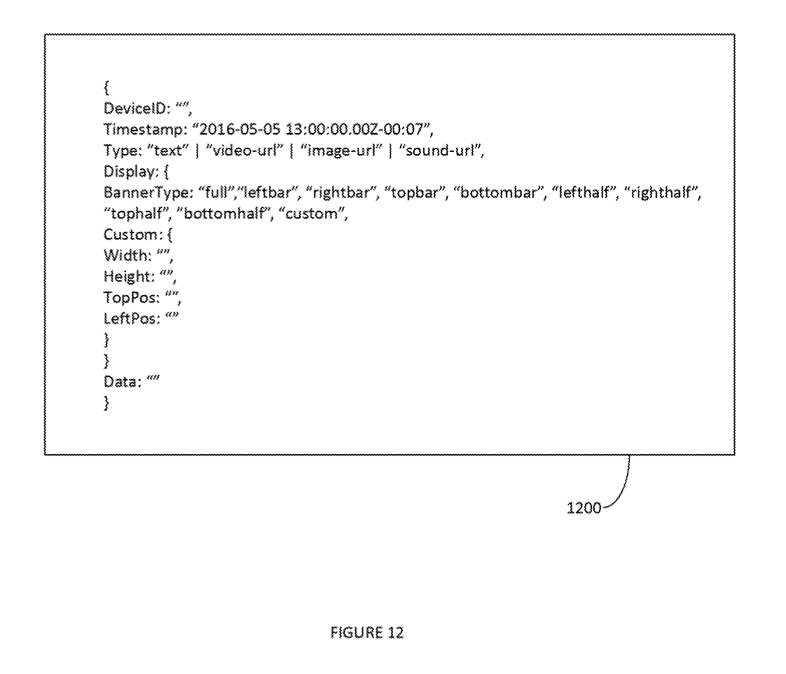

FIG. 12 illustrates a screen shot of code instructions 1200, according to some embodiments. Code instructions 1200 can be sent as events on either a persistent connection or event notifications. When a video-overlay device receives code instructions 1200, a video-overlay application operative in the video-overlay device can render the visual and/or audio properly per the instructions in code instructions 1200. An explanation of code instructions 1200 is now provided. ‘Device ID’ can be an identifier of the targeted device for code instructions 1200. ‘Timestamp’ can be a time when code instructions 1200 was created. ‘Type’ can be the type of instruction is encoded. ‘Display’ can provide instructions on how to display the content. ‘Data’ can be the text, encoded text (e.g. HTML, etc.), binary, link (e.g. hyperlink to an audio, video, or data) which the application on the device can understand and use display the managed/customized video content correctly. This can be implemented by Video-overlay device 618.

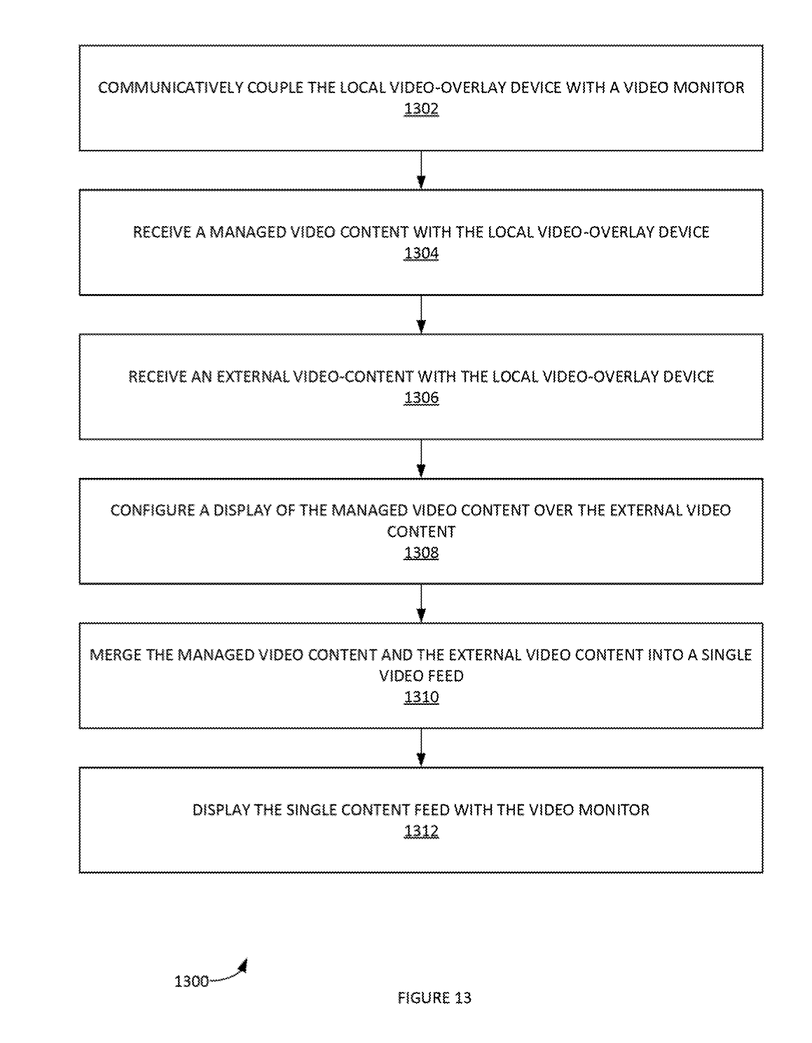

FIG. 13 illustrates an example process 1300 for a local business entity to generated a managed video that is generated for a specific customer on the premises of the local business entity and to overlay the customized video content over an external video feed, according to some embodiments. In step 1300, process 1302 can communicatively couple the local video-overlay device with a video monitor. In step 1304, process 1300 can receive a managed video content with the local video-overlay device. In step 1306, process 1300 can receive an external video-content with the local video-overlay device. In step 1308, process 1300 can configure a display of the managed video content over the external video content. In step 1310, process 1300 can merge the managed video content and the external video content into a single video feed. In step 1312, process 300 can display the single content feed with the video monitor.

The systems and methods provided supra can be utilized at an auto dealer waiting area. For example, while a customer is watching news or television show on a television monitor in a waiting area, a message can be shown to indicate the status of their vehicle being serviced. An advertisement of recommended accessories can be displayed on top of the current television show content to entice the customer to purchase accessories. In another example, the advertisement for a newer model of a similar vehicle the customer would be interested in upgrading to. These advertisements can be tailored to the specific customers presumed to be in the waiting area.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an Illustrative rather than a restrictive sense. In some embodiments, the machine-readable medium can be a non-transitory form of machine-readable medium.

What is claimed as new and desired to be protected by Letters Patent of the United States is:

1. A computerized method useful for a local business entity to generated a managed video that is generated for a specific customer on the premises of the local business entity and to overlay the customized video content over an external video feed comprising:
communicatively coupling the local video-overlay device with a video monitor;
receiving a managed video content with the local video-overlay device;
receiving an external video-content with the local video-overlay device;
configuring a display of the managed video content over the external video content;
merging the managed video content and the external video content into a single video feed; and
displaying the single content feed with the video monitor.

2. The computerized method of claim 1, wherein the video monitor comprises a television monitor.

3. The computerized method of claim 1, wherein the external video-content source comprises a television video feed that is digitally distributed via the Internet or a cable television network.

4. The computerized method of claim 1, wherein the managed video content further comprises an audio content.

5. The computerized method of claim 1, wherein the managed content comprises a video advertisement overlaid on display of the external video content with the video monitor.

6. The computerized method of claim 1, wherein the managed video content is pushed to the video-overlay device from a server managed by a local business entity that manages the video monitor.

7. The computerized method of claim 6,
wherein the local business entity comprises an automobile dealership,
wherein the managed video content comprises a notification message specific to a single customer located at the automobile dealership.

8. The computerized method of claim 7, wherein the information specific to a single customer comprises an email content of the single customer, an online social network post to the single customer, or a business application data pushed to the single customer via the video monitor.

9. The computerized method of claim 1, wherein the local video-overlay device configures the managed video content as a Picture-in-picture (PiP) banner to overlay a specified area of the external video content.

10. A computer system useful for a local business entity to generated a customized video that is generated for a specific customer on the premises of the local business entity and to overlay the customized video content over an external video feed comprising:
a processor;
a memory containing instructions when executed on the processor, causes the processor to perform operations that:
communicatively couple a local video-overlay device with a video monitor;
receive a customized video content with the local video-overlay device, wherein the local video-overlay device configures the customized video content a Picture-in-picture (PiP), banner to overlay a specified area of the external video content;
receiving an external video-content with the local video-overlay device;
configuring a display of the customized video content over the external video content;
merging the customized video content and the external video content into a single video feed; and
displaying the single content feed with the video monitor.

11. The computerized system of claim 10, wherein the video monitor comprises a television monitor.

12. The computerized system of claim 11, wherein the external video-content source comprises a television video feed that is digitally distributed via the Internet or a cable television network.

13. The computerized system of claim 12, wherein the local video-overlay device configures the customized video content as a Picture-in-picture (PIP) banner to overlay a specified area of the external video content.

14. A computerized video hub for pushing managed content while displaying another video source comprising:
a video-overlay device coupled with a video display monitor, wherein the video display monitor is located in a building of a local entity and wherein the video-overlay device:
obtains an existing video feed from a source external to the local entity and overlays;
obtains a custom video feed generated by the local entity and pushed by the local entity to the video-overlay device, wherein the custom video feed further comprises a dimension parameter, a location parameter and a time parameter associated with a display of the custom video feed over the existing video feed;
overlay an application user interface (UI) in the video display monitor to display the existing video feed and the custom video feed generated by the local entity;
displays the custom video feed according to the dimension parameter, a location parameter and a time parameter on the video display monitor.
